(19) United States
(12) Patent Application Publication
(10) Pub. No.: US 2005/0018767 A1
(43) Pub. Date: Jan. 27, 2005

(54) Apparatus and method for detecting film mode

(75) Inventor: Young-ho Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/871,375

(22) Filed: Jun. 21, 2004

(30) Foreign Application Priority Data
Jul. 21, 2003 (KR) 2003-49908

(51) Int. Cl. H04N 7/12

(52) U.S. Cl. 375/240.1

(57) ABSTRACT

An apparatus and method for detecting a film mode with respect to an input image signal. The apparatus includes a main detection unit for calculating summed absolute differences (SADs) between I period-spaced-fields with respect to an input image signal and detecting a film mode based on the SADs, a sub-detection unit for calculating an absolute change amount between the SADs and detecting the film mode based on the absolute change amounts, a still image judgment unit judging whether the input image signal is a still image based on the SADs and the absolute change amounts, and a film mode decision unit for deciding whether the input image signal is in the film mode by combining results of detecting the film mode by the main detection unit and by the sub-detection unit and a result of judging whether the image signal is the still image by the still image judgment unit.

### CROSS-REFERENCE TO RELATED APPLICATIONS

This application claims the benefit of Korean Patent Application No. 2003-49908, dated Jul. 21, 2003, in the Korean Intellectual Property Office, the disclosure of which is incorporated herein by reference.

### BACKGROUND OF THE INVENTION

1. Field of the Invention

The present invention relates to an apparatus and a method for detecting a film mode of an image signal, and more particularly, to an apparatus and a method for detecting whether an inputted image signal is a 3:2 pull-down film mode.

2. Description of the Related Art

Humans perceive a continuous image if 16 or more sheets of pictures per second appear. That is, in an image in motion, 16 sheets of pictures per second correspond to a minimum sampling frequency (i.e., Nyquist frequency) for sampling a signal with information preserved. In consideration of this, an image for a movie is processed at a speed of 24 sheets of pictures per second, and an image for a television (TV) is processed at a speed of 25 to 30 sheets of pictures per second.

The movie uses a progressive system that instantaneously stores every picture in a film and progressively projects the pictures on a screen. Compared to this progressive system of the movie, in the TV, since an image is basically transmitted over the air, each picture is filmed and transmitted through scanning of several hundreds of scanning lines, and then displayed on a screen of a Braun tube by scanning. In the NTSC (National Television System Committee) color TV system adopted in the United States, Japan, Korea, etc., 30 sheets of pictures, each of which is composed of 525 scanning lines, per second are transmitted, and in the PAL (Phase Alternation by Line) system or SECAM (Sequential Couleur a Memoire) system, 25 sheets of pictures, each of which is composed of 625 scanning lines, per second are transmitted.

Also, the TV uses an interlaced scanning method which divides one picture (i.e., frame) into two fields and alternately scans the two fields in order to effectively present a moving image using limited scanning lines. At this time, the divided fields are called top and bottom fields, odd and even fields, upper and lower fields, etc. Accordingly, the NTSC system processes 60 fields of image per second, and the PAL or SECAM system processes 50 fields of image per second.

When a movie is televised through a TV, every sheet of movie film is scanned and transmitted through a converter called a telecine (which is a compound word of a television and a cinema). At this time, if the films are reproduced at TV picture reproducing speed without getting the number of film pictures per second to equal to the number of television pictures per second, since the NTSC system provides 30 sheets of pictures per second, a viewer watches an image in a fast motion. Accordingly, in order to transmit the movie films to the television of the NTSC system, 24 sheets of film pictures per second have to be translated into 60 television fields. This translation is achieved by obtaining 5 fields from 2 sheets of film pictures. A simple and practically used method is to scan 3 fields for the first film picture and scan 2 fields for the other, which is called “3:2 pull down method”.

Basically, it is possible to reproduce an original image of 24 frames such as an original movie through a DVD (Digital Video Disk). However, since the majority of currently available display devices such as a television use an interlaced scanning method, the DVD is actually manufactured to match with the interlaced scanning method. Accordingly, in order to restore the title created in the interlaced scanning method to the progressive system, the 3:2 pull-down method should be performed in a reverse manner. It is most important in such a de-interlacing work to accurately recognize the 3:2 pull-down sequence (Such a 3:2 pull-down state is called “film mode” because it is mainly applied in a movie).

FIG. 1 is a view showing the 3:2 pull down processing. Referring to FIG. 1, two frames are scanned into 5 fields. One film frame is composed of a top field of odd-number lines and a bottom field of even-number lines. For obtaining 3 fields from one frame for a television, any one of the top field and the bottom field has to be repeatedly used. In the drawing, a top field of a frame 1 is expressed by T1, a bottom field of the frame 1 by B1, a top field of a frame 2 by T2, and a bottom field of the frame 2 by B2.

FIG. 2 is a block diagram showing a conventional film mode detection process. Referring to FIG. 2, in a case that 10 fields detected as the 3:2 pull down sequence are referred to as F1, F2, F3, F4, F5, F6, F7, F8, F9, and F10, a film mode is detected by using the fact that a period of Summed Absolute Difference (SAD) is 5. That is, if the SAD is obtained by period of two fields, the SADs of F1−F3, F6−F8 are small (If there is no noise, the SAD is approximately 0). The SADs are small because the repeated field is subtracted from the original field. By using this regularity, a film mode detection performs a subtract operation to pixel values between two fields having 1/30 second interval therebetween (204), obtains an absolute value of difference thereof (205), and then creates an intermediate data by adding up the absolute values to all the pixels (206). For example, if |F1−F3|=D1, |F2−F4|=D2, |F3−F4|=D3, . . . , SADs D1 and D6 have very small values and the remaining SADs have large values. The SADs have a regularity of small, large, large, large, small.

In a case that there occurs an error in converting a picture, however, the SAD greatly increases. In consideration of this, a limiting is performed with a threshold value M1 such that SADs larger than the threshold value M1 are substituted by the threshold value M1 (207). Through the limiting, the sequence of SAD D1, D2, D3, . . . has a waveform having a period of 5 and an amplitude width movable within a limitation. When such a waveform is passed through a digital threshold bandpass filter (208) having a center of 2π/5 and DC gain of 0, if the waveform has a period of 5, a signal similar to a sine wave having a predetermined amplitude width is output. Otherwise, the signal as outputted is approximately 0. When a calculation is performed with respect to the power of the signal similar to the sine wave (209), a power value is large if the signal has a period of 5. Otherwise, the power value is approximately 0. Accordingly, if the calculated power value is greater than a predetermined threshold value M2, it is determined that the signal is in a film mode. Otherwise, it is determined that the signal is not in a film mode (210).

The SAD between two fields of the 3:2 pull downed stream having a 1/30 second interval therebetween has a period of 5, but the periodicity brakes when there is noise. Also, when the limiting block removes a peak which appears when a picture is converted, since the peak is removed by a predetermined value even in the case that the SAD has a small value according to the input stream, an incorrect value may be outputted. Also, the mode detection block has to have a predetermined threshold value, but in such a case, since a power is varied depending on the input stream, it is incorrect to set the threshold value to a fixed value.

Accordingly, even if the conventional film mode detection method properly sets a threshold through many experiments, it cannot accurately detect a film mode in a case that there is much noise in the input stream and much variation in the SAD.

### SUMMARY OF THE INVENTION

The present invention has been developed in order to solve the above problems in the related art. Accordingly, an aspect of the present invention provides an apparatus and a method for detecting a film mode, which are capable of accurately detecting the film mode even in the case of having much noise and also much variation in the SADs.

The above aspect is achieved by providing an apparatus for detecting a film mode, comprising a main detection unit for calculating a summed absolute difference (SAD) between 1 period-spaced-fields with respect to an input image signal and detecting a film mode based on the calculated SADs; a sub-detection unit for calculating an absolute change amount between the calculated SADs and detecting the film mode based on the absolute change amounts; a still image judgment unit for judging whether the input image signal is a still image based on the calculated SADs and the absolute change amounts; and a film mode decision unit for deciding whether the input image signal is the film mode by combining results of detecting film mode by the main detection unit and by the sub-detection unit and a result of judging whether the image signal is the still image by the still image judgment unit.

In an exemplary embodiment, the main detection unit comprises a SAD calculation unit for calculating the SAD between the 1 period-spaced-fields of the image signal; a SAD storage unit for sequentially storing the calculated SADs; a first threshold value calculation unit for calculating a first threshold value using the stored SADs; a first pattern generation unit for generating patterns of the SADs according to the calculated first threshold value; a first pattern storage unit for sequentially storing the patterns of the SADs generated by the first pattern generation unit; and a first pattern comparison unit for comparing the pattern of the SAD stored in the first pattern storage unit with a predetermined basic pattern of the SAD. At this time, the main detection unit detects the film mode according to a result of comparison by the first pattern comparison unit.

Also, in an exemplary embodiment, the first threshold value calculation unit comprises: a first minimum value detection unit for detecting a minimum value of the SADs with respect to five consecutive SADs stored in the SAD storage unit; and a first maximum value detection unit for detecting a maximum value of the SADs with respect to the five consecutive SADs. At this time, the first threshold value calculation unit calculates the first threshold value based on the detected minimum and maximum values.

Also, in an exemplary embodiment, the first threshold value calculation unit calculates the first threshold value by the following equation,
T1=a×MIN+b×MAX

wherein T1 denotes the first threshold value, a and b are certain values keeping a+b=1, MIN denotes the minimum value of 5 consecutive SADs, and MAX denotes the maximum value of the 5 consecutive SADs.

Also, the sub-detection unit comprises: an absolute change amount calculation unit for calculating the absolute change amount between the calculated SADs; an absolute change amount storage unit for sequentially storing the absolute change amounts; a second threshold value calculation unit for calculating a second threshold value using the stored absolute change amounts; a second pattern generation unit for generating patterns of the absolute change amounts according to the calculated second threshold value; a second pattern storage unit for sequentially storing the patterns of the absolute change amounts generated by the second pattern generation unit; and a second pattern comparison unit for comparing the pattern of the absolute change amount stored in the second pattern storage unit with a predetermined basic pattern of the absolute change amount. At this time, the sub-detection unit detects the film mode according to a result of comparison by the second pattern comparison unit.

Also, in an exemplary embodiment, the second threshold value calculation unit comprises: a second minimum value detection unit for detecting a minimum value of the five consecutive absolute change amounts stored in the absolute change amount storage unit; and a second maximum value detection unit for detecting a maximum value of the five consecutive absolute change amounts. At this time, the second threshold value calculation unit calculates the second threshold value based on the detected minimum and maximum values.

In an exemplary embodiment, the second threshold value calculation unit calculates the second threshold value by the following equation,
T2=a′×MIN′+b′×MAX′

wherein T2 denotes the second threshold value, a′ and b′ are certain values keeping a′+b′=1, MIN′ denotes the minimum value of 5 consecutive absolute change amounts, and MAX′ denotes the maximum value of the 5 consecutive absolute change amounts. Also, the still image judgment unit judges whether the image signal is the still image according to the pattern of the SAD stored in the first pattern storage unit and the pattern of the absolute change amount stored in the second pattern storage unit.

Meanwhile, a method for detecting a film mode according to the present invention, comprises: a main detection step of calculating a summed absolute difference (SAD) between 1 period-spaced-fields with respect to an input image signal, and detecting a film mode based on the calculated SADs; a sub-detection step of calculating an absolute change amount between the calculated SADs, and detecting the film mode based on the calculated absolute change amounts; a step of judging whether the input image signal is a still image based on the calculated SADs and the absolute change amounts; and a step of deciding whether the input image signal is in the film mode by combining results of detecting the film mode by the main detection step and by the sub-detection step and a result of judging whether the image signal is the still image by the still image judgment step.

Accordingly, the apparatus for detecting the film mode accurately detects the film mode even in the case of much noise and much variation in the SADs.

### BRIEF DESCRIPTION OF THE DRAWINGS

The above aspect and other advantages of the present invention will become more apparent by describing in detail the exemplary embodiments thereof with reference to the attached drawings, in which:

FIG. 1 is a view explaining a 3:2 pull-down process;

FIG. 2 is a block diagram showing a conventional film mode detection process;

FIG. 3 is a block diagram showing an apparatus for detecting a film mode according to the present invention;

FIG. 4 is a block diagram showing the first threshold value calculation unit of FIG. 3;

FIG. 5 is a block diagram showing the second threshold value calculation unit of FIG. 3;

FIG. 6 is a view explaining the relation between the SAD pattern storage unit and the absolute change amount storage unit;

FIG. 7 is a flowchart showing a method for detecting a film mode performed by the apparatus of FIG. 3;

FIG. 8 is a flowchart showing a film mode detection process performed by the main detection unit of FIG. 7;

FIG. 9 is a flowchart showing a film mode detection process performed by the sub-detection unit of FIG. 7;

FIG. 10 is a view showing the SADs and the absolute change amounts of FIG. 7; and

FIG. 11 is a view showing one example of the patterns of SADs and the patterns of the absolute change amounts.

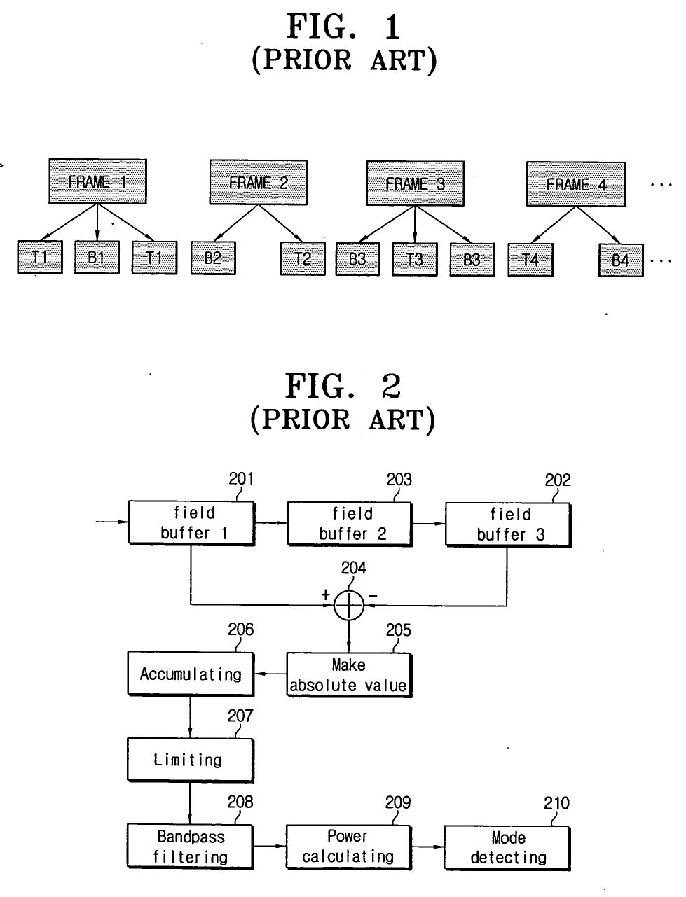

### DETAILED DESCRIPTION OF THE ILLUSTRATIVE, NON-LIMITING EMBODIMENTS

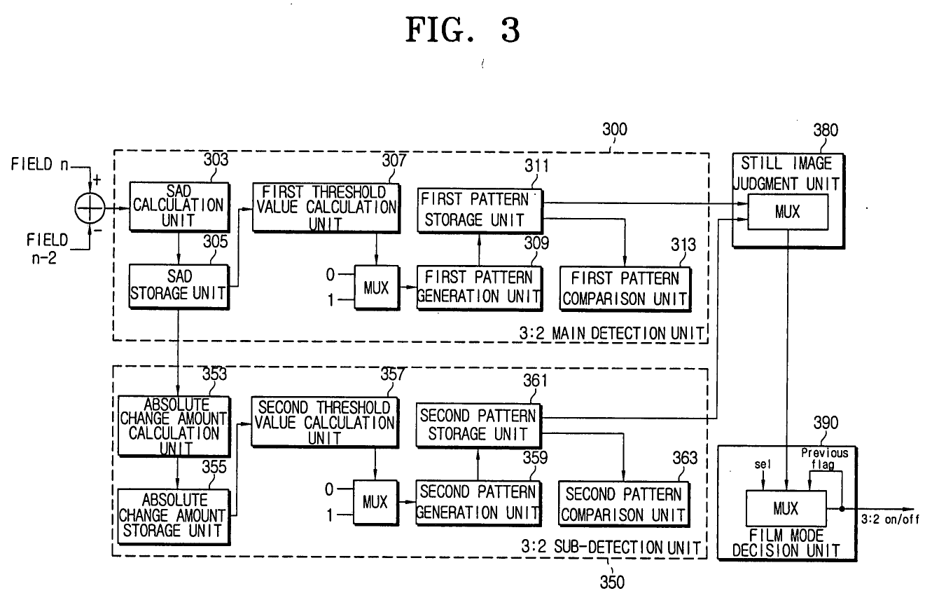

FIG. 3 is a block diagram showing an apparatus for detecting a film mode according to an exemplary embodiment of the present invention. Referring to FIG. 3, the apparatus for detecting a film mode includes a main detection unit 300, a sub-detection unit 350, a still image judgment unit 380, and a film mode decision unit 390.

The main detection unit 300 calculates a summed absolute difference (SAD) between fields spaced from each other by one period with respect to an input image signal, and detects a film mode based on the calculated SADs. The sub-detection unit 350 calculates an absolute change amount between the calculated SADs, and detects the film mode based on the calculated absolute change amounts. The still image judgment unit 380 judges whether the input image signal is a still image, based on the calculated SADs and the absolute change amounts. The film mode decision unit 390 decides whether the input image signal is a film mode, by combining results of detecting the film mode by the main detection unit 300 and the sub-detection unit 350 and a result of judging whether the image signal is a still image by the still image judgment unit 380.

Meanwhile, the main detection unit 300 includes a SAD calculation unit 303, a SAD storage unit 305, a first threshold value calculation unit 307, a first pattern generation unit 309, a first pattern storage unit 311, and a first pattern comparison unit 313.

The SAD calculation unit 303 calculates the SAD between the 1 period-spaced-fields of the image signal. The SAD storage unit 305 sequentially stores the SADs calculated by the SAD calculation unit 303. In order to sequentially store the calculated SADs, the SAD storage unit 305 is implemented by a predetermined number of FIFO (First-In First-Out) buffers. The first threshold value calculation unit 307 calculates a first threshold value using the stored SADs. The first pattern generation unit 309 generates patterns of the SADs according to the calculated first threshold value. The first pattern storage unit 311 sequentially stores the patterns of the SADs generated by the first pattern generation unit 309. In order to sequentially store the SAD patterns generated by the first pattern generation unit 309, the first pattern storage unit 311 is implemented by a predetermined number of FIFO buffers. The first pattern comparison unit 313 compares the pattern of the SAD stored in the first pattern storage unit 311 with a predetermined basic pattern of the SAD.

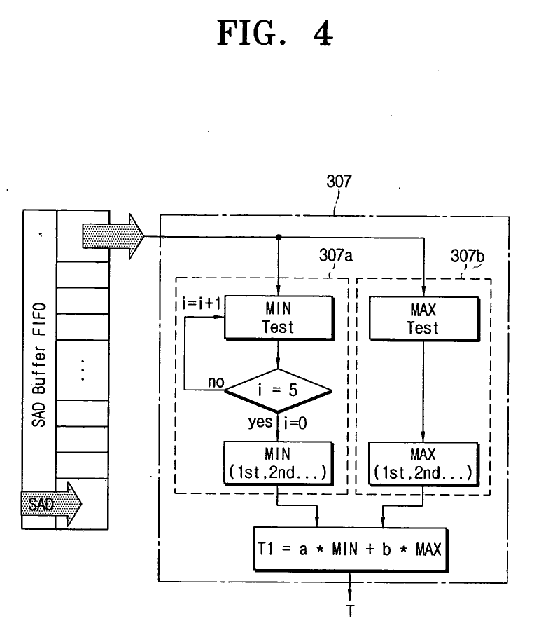

Also, the first threshold value calculation unit 307 includes a first minimum value detection unit 307a and a first maximum value detection unit 307b (see FIG. 4). The first minimum value detection unit 307a detects a minimum value with respect to 5 consecutive SADs of the SADs stored in the SAD storage unit 305. The first maximum value detection unit 307b detects a maximum value with respect to the 5 consectuive SADs. In this case, since the film mode showing the 3:2 pull-down has a minimum value of the SADs once in five (5) periods, the first minimum value detection unit 307a detects a minimum value once in five (5) periods so that the load to the operation can be lessened.

Meanwhile, the sub-detection unit 350 includes an absolute change amount calculation unit 353, an absolute change amount storage unit 355, a second threshold value calculation unit 357, a second pattern generation unit 359, a second pattern storage unit 361, and a second pattern comparison unit 363. The absolute change amount calculation unit 353 calculates an absolute change amount between the SADs calculated by the SAD calculation unit 303. The absolute change amount storage unit 355 sequentially stores the calculated absolute change amounts. The second threshold value calculation unit 357 calculates a second threshold value using the stored absolute change amounts. The second pattern generation unit 359 generates patterns of the absolute change amounts according to the calculated second threshold value. The second pattern storage unit 361 sequentially stores the patterns of the absolute change amounts generated by the second pattern generation unit 359. In this case, it is preferable that the absolute change amount storage unit 355 and the second pattern storage unit 361 are implemented by FIFO buffers in the same manner as the SAD storage unit 305 and the first pattern storage unit 311.

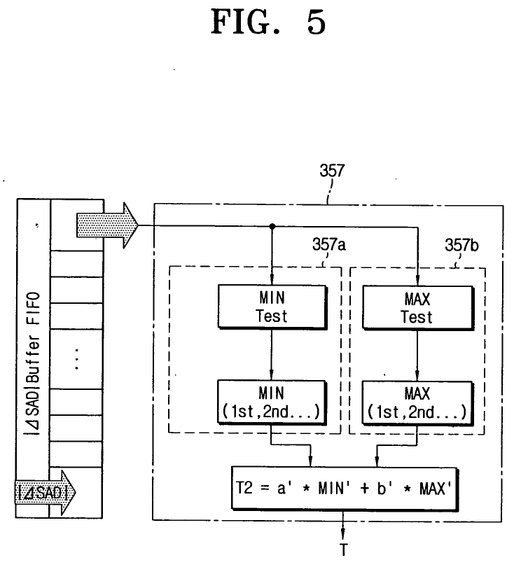

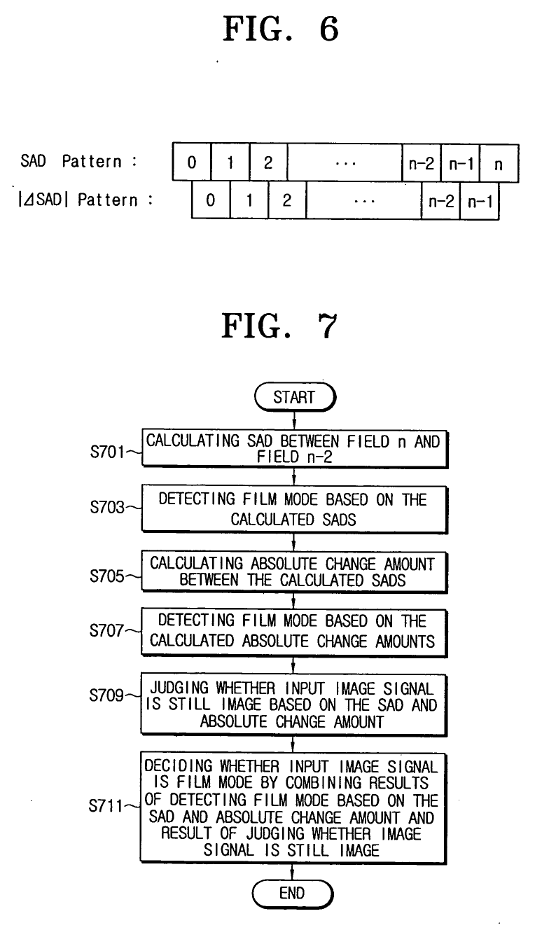

The second pattern comparison unit 363 compares the pattern of the absolute change amount stored in the second pattern storage unit 361 with a predetermined basic pattern of the absolute change amount. Also, the second threshold value calculation unit 357 includes a second minimum value detection unit 357a and a second maximum value detection unit 357b (see FIG. 5). The second minimum value detection unit 357a detects a minimum value with respect to five consecutive absolute change amounts among the absolute change amounts stored in the absolute change amount storage unit 355. The second maximum value detection unit 357b detects a maximum value with respect to the five consecutive change amounts. In an exemplary embodiment, the second pattern storage unit 361 is implemented so that the absolute change amounts between the SADs stored in the first pattern storage unit 311 are sequentially stored in the second pattern storage unit 361. The relation between the first pattern storage unit 311 and the second pattern storage unit 361 is illustrated in FIG. 6.

FIG. 7 is a flowchart illustrating a method of detecting a film mode performed by the apparatus for detecting a film mode according to an exemplary embodiment of the present invention.

Referring to FIG. 7, the SAD calculation unit 303 of the main detection unit 300 calculates the SAD between 1 period-spaced-fields of an input image signal (S701). That is, if it is defined that a currently inputted field is called a ‘present field’ (n), a field before the present field n by one period is called a ‘previous field’ (n−1), and a field after the present field n by one period is called a ‘next field’ (n+1), the SAD calculation unit 303 calculates the SAD between the 1 period-spaced-fields by calculating the difference of pixel values between the previous field (n−1) and the next field (n+1).

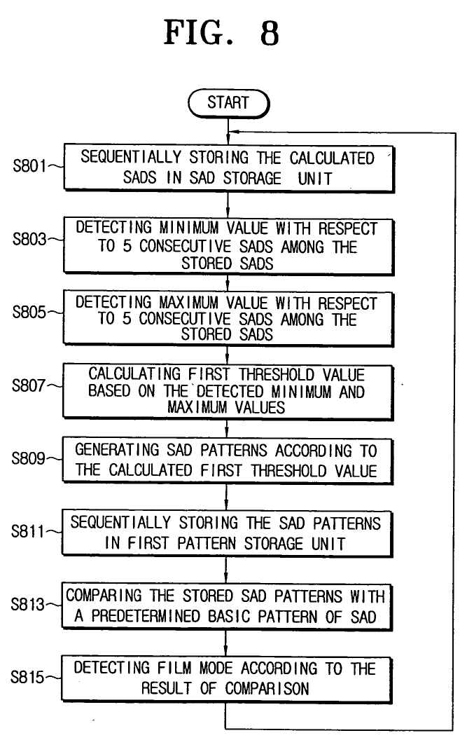

The main detection unit 300 detects whether the input image signal is a 3:2 pull-down image, i.e., whether it is in a film mode, based on the calculated SADs (S703). The process of detecting a film mode by the main detection unit 300 is illustrated in FIG. 8.

Referring to FIG. 8, the SAD storage unit 305 sequentially stores the SADs calculated by the SAD calculation unit 303 (S801). The first minimum value detection unit 307a of the first threshold value calculation unit 307 detects the minimum value with respect to the five consecutive SADs among the SADs stored in the SAD storage unit 305 (S803). Since the same field is repeated by the same frame once in five periods in the 3:2 pull down image, the first minimum value detection unit 307a may be implemented so as to detect the minimum value once in five periods. The first maximum value detection unit 307b of the first threshold value calculation unit 307 detects the maximum value with respect to the five consecutive SADs of the SAD storage unit 305 (S805).

The first threshold value calculation unit 307 calculates the first threshold value based on the minimum value and the maximum value of the SADs detected by the first minimum value detection unit 307a and the first maximum value detection unit 307b, and the first threshold value is calculated by the following equation.
T1=a×MIN+b×MAX [Equation 1]

Here, T1 denotes the first threshold value, a and b are certain values keeping a+b=1, MIN denotes the minimum value with respect to the five consecutive SADs, and MAX denotes the maximum value with respect to the five consecutive SADs.

The first pattern generation unit 309 generates patterns of the SADs stored in the SAD storage unit 305 according to the first threshold value calculated by the first threshold value calculation unit 307 (S809). In this case, the first pattern generation unit 309 compares the SAD with the first threshold value calculated by the first threshold value calculation unit 307, and generates ‘1’ if the SAD is larger than the first threshold value. Otherwise, the first pattern generation unit 309 generates ‘0’.

The first pattern storage unit 311 sequentially stores the patterns of the SADs generated by the first pattern generation unit 309 (S811). The first pattern comparison unit 313 compares the pattern of the SAD stored in the first pattern storage unit 311 with the predetermined basic pattern of the SAD (S813). Here, the basic pattern of the SAD means the basic pattern of the SAD of the 3:2 pull-down image, and appears with five types. That is, the five types of the basic pattern of the SAD are 0111101111, 1011110111, 1101111011, 1110111101, and 1111011110. The main detection unit 300 detects the film mode according to a result of comparison by the first pattern comparison unit 313 (S815). This process of detecting the film mode is repeatedly performed with respect to the input image signal. In the case that the picture is abruptly changed, the film mode detection process can properly cope with the changed picture.

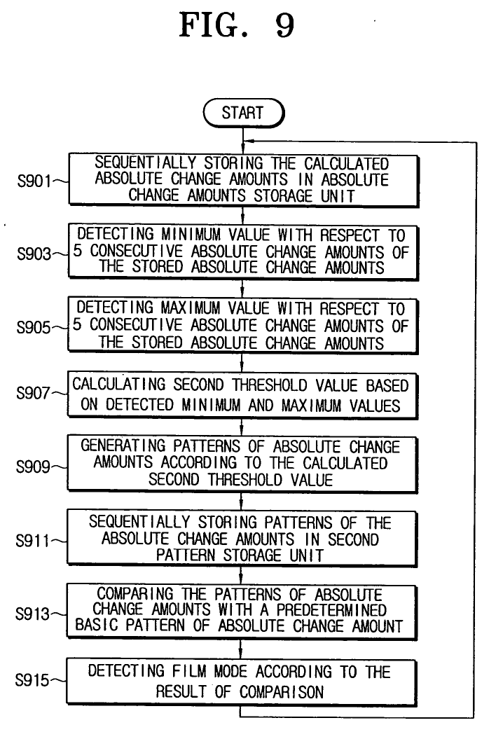

Meanwhile, the absolute change amount calculation unit 353 of the sub-detection unit 350 calculates the absolute change amount between the SADs calculated by the SAD calculation unit 303 (S705). That is, if it is defined that the difference of pixel values between the ‘previous field’ (n−1) and the next (n+1) is SAD1, and the difference of pixel values between the present field (n) and the next field (n+1) is SAD2, the absolute change amount calculation unit 353 calculates a difference between the absolute values of SAD1 and SAD2, i.e., the absolute change amount. The sub-detection unit 350 detects whether the input image signal is a 3:2 pull-down image based on the absolute change amounts calculated by the absolute change amount calculation unit 353 (S707). The process of detecting a film mode performed by the sub-detection unit 350 is illustrated in FIG. 9.

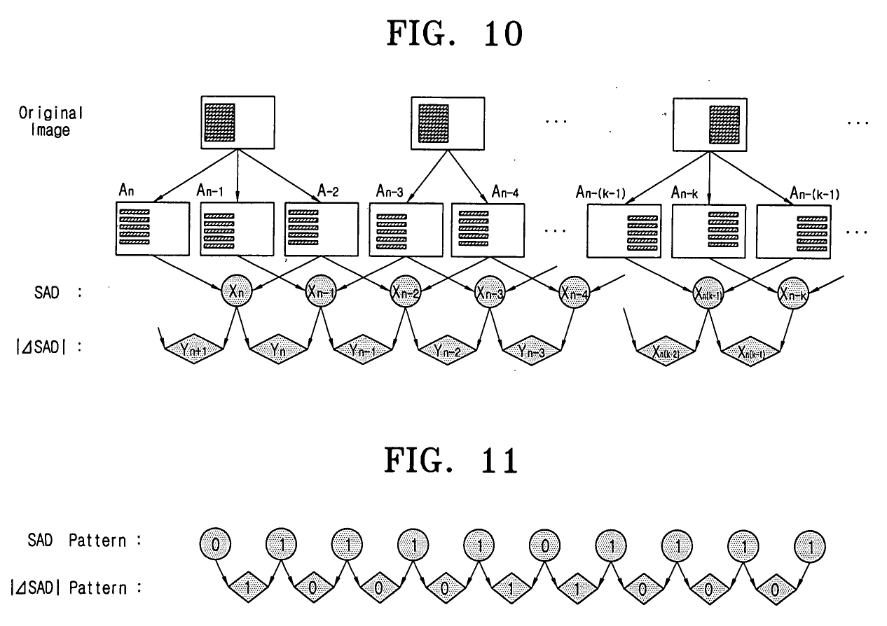

Referring to FIG. 9, the absolute change amount storage unit 355 sequentially stores the absolute change amounts calculated by the absolute change amount calculation unit 353 (S901). The SAD and absolute change amount in this case are illustrated in FIG. 10. The second minimum value detection unit 357a of the second threshold value calculation unit 357 detects the minimum value with respect to five consecutive absolute change amounts of the absolute change amounts stored in the absolute change amount storage unit 355 (S903). The second maximum value detection unit 357b of the second threshold value calculation unit 357 detects the maximum value with respect to the five consecutive absolute change amounts of the absolute change amounts stored in the absolute change amount storage unit 355 (S905).

The second threshold value calculation unit 357 calculates the second threshold value based on the minimum value and the maximum value of the absolute change amounts detected by the second minimum value detection unit 357a and the second maximum value detection unit 357b, and the second threshold value is calculated by the following equation.
T2=a′×MIN′+b′×MAX′ [Equation 2]

Here, T2 denotes the second threshold value, a′ and b′ are certain values keeping a′+b′=1, MIN′ denotes the minimum value of the five consecutive absolute change amounts, and MAX′ denotes the maximum value of the five consecutive absolute change amounts.

The second pattern generation unit 359 generates patterns of the absolute change amounts stored in the absolute change amount storage unit 355 according to the second threshold value calculated by the second threshold value calculation unit 357 (S909). In this case, the second pattern generation unit 359 compares the absolute change amount with the second threshold value calculated by the second threshold value calculation unit 357, and generates ‘1’ if the absolute change amount is larger than the second threshold value. Otherwise, the second pattern generation unit 359 generates ‘0’.

The second pattern storage unit 361 sequentially stores the patterns of the absolute change amounts generated by the second pattern generation unit 359 (S911). The second pattern comparison unit 363 compares the pattern of the absolute change amount stored in the second pattern storage unit 361 with the predetermined basic pattern of the absolute change amount (S913). Here, the basic pattern of the absolute change amount means the basic pattern of the absolute change amount of the 3:2 pull-down image, and appears with five types. That is, the five types of the basic pattern of the absolute change amount are 1000110001, 1100011000, 0110001100, 0011000110, and 0001100011. The basic pattern of the absolute change amount is illustrated in FIG. 11. The sub-detection unit 350 detects a film mode according to a result of comparison by the second pattern comparison unit 363 (S915).

The still image judgment unit 380 judges whether the input image signal is a still image based on the SAD and the absolute change amount (S709). For example, if the presently calculated SAD and the SAD calculated before one field are very small in comparison to the previous SAD, and if the absolute change amount between the presently calculated SAD and the SAD calculated before one field is very small in comparison to the previous absolute change amount, the present input image is close to a still image. In this case, the pattern of the SAD and the pattern of the absolute change amount stored in the first pattern storage unit 311 and the second pattern storage unit 361 are as follows.
SAD_pattern[n−1]=0
SAD_pattern[n]=0
|ΔSAD|_pattern[n−1]=0

The film mode decision unit 390 decides whether the input image signal is the film mode by combining results of detecting the film mode by the main detection unit 300 and by the sub-detection unit 350 and a result of judging whether the image signal is the still image by the still image judgment unit 380. At this time, if it is judged that the input image signal is the still image by the still image judgment unit 380, the present patterns of the SAD and the absolute change amount deviate from the 3:2 pull-down image, but the previous 3:2 pull-down image flag is maintained as it is. Several examples of deciding film mode by the film mode decision unit 390 are shown in Table 1 below.

TABLE 1

| | Previous | | | | |
|---|---|---|---|---|---|
| Decision | Flag | Still Flag | Main | Sub | Count |
| 0 | 0 | X | 1 | 1 | count < ε |
| 1 | 0 | X | 1 | 1 | count = ε |
| 1 | 1 | 0 | 1 | 1 | X |
| 0 | 1 | 0 | 0 | X | X |
| 1 | 1 | 0 | 1 | 0 | X |
| 1 | 1 | 1 | X | X | X |

The film mode decision unit 390 outputs the 3:2 pull-down image according to the results of detection by the main detection unit 300 and the sub-detection unit 350 and the previous flag. For example, if the previous flag is “0”, and the counted value of the input image signal is smaller than a predetermined value, i.e., if the film mode detected by the main detection unit 300 and the sub-detection unit 350 does not continue for a predetermined time, the film mode decision unit 390 maintains the previous flag irrespective of the still flag, and outputs “0”. If the main detection unit 300 and the sub-detection unit 350 detect the film mode in a state that the previous flag is “0” and the counted value of the input image signal reaches the predetermined value, the film mode decision unit 390 reverses the previous flag irrespective of the still flag, and outputs “1”. Here, the fact that the previous flag is “0” means that the 3:2 pull-down image is not decided with respect to the previous image signal.

If the previous flag is “1”, i.e., if the 3:2 pull-down image is decided with respect to the previous image signal, the film mode decision unit 390 decides the film mode irrespective of the counted value. That is, in the case that the previous flag is “1”, if the film mode is detected by the main detection unit 300 and the sub-detection unit 350 and the input image is not decided to be the still image by the still image judgment unit 380, the film mode decision unit 390 decides that the input image is the 3:2 pull-down image. Also, if the still flag is “0”, i.e., if the input image is judged not to be the still image by the still image judgment unit 380, in the case that the film mode is detected by the main detection unit 300 but the film mode is not detected by the sub-detection unit 350, the film mode decision unit 390 decides that the input image is the 3:2 pull-down image.

However, if the still flag is “1” in the case that the previous flag is “1”, the film mode decision unit 390 maintains the previous flag irrespective of the detection of the film mode by the main detection unit 300 and the sub-detected unit 350, and decides that the input image signal is the 3:2 pull-down image. This is to prevent the displayed image from being unnatural due to the frequent on/off operation of the 3:2 pull-down image flag. If the still image in non-film mode is inputted after the film mode image signal is inputted, there will not be an ill effect on the displayed image even though the film mode image process is performed with respect to the still image.

Consequently, the apparatus for detecting a film mode according to the present invention can accurately detect the film mode using the SAD and the absolute change amount. Also, the apparatus can prevent the displayed image from being unnatural by reducing the frequency of on/off operations of the 3:2 pull-down image flag.

As described above, since the apparatus for detecting a film according to the present invention judges the film mode by calculating a proper threshold value according to the changes of the SAD and the absolute change amounts of the input image signal, it can decide the film mode accurately even in the case of having much noise and motion in the input image signal.

Also, the unnatural display image due to the frequent on/off operations of the 3:2 pull-down image flag can be prevented.

While the present invention has been described in detail, it should be understood that various changes, substitutions and alterations can be made hereto without departing from the spirit and scope of the invention as defined by the appended claims.

1. An apparatus for detecting a film mode, comprising:
a main detection unit for calculating summed absolute differences (SADS) between fields spaced from each other by one period with respect to an input image signal and detecting the film mode based on the calculated SADs;
a sub-detection unit for calculating an absolute change amount between the calculated SADs and detecting the film mode based on the absolute change amounts;
a still image judgment unit for judging whether the input image signal is a still image based on the calculated SADs and the absolute change amounts; and
a film mode decision unit for deciding whether the input image signal is in the film mode by combining results of detecting the film mode by the main detection unit and by the sub-detection unit and a result of judging whether the image signal is the still image by the still image judgment unit.

2. The apparatus as claimed in claim 1, wherein the main detection unit comprises:
a SAD calculation unit for calculating the SADs between the 1 period-spased-fields of the image signal;
a SAD storage unit for sequentially storing the calculated SADs;
a first threshold value calculation unit for calculating a first threshold value using the stored SADs;
a first pattern generation unit for generating patterns of the SADs according to the calculated first threshold value;
a first pattern storage unit for sequentially storing the patterns of the SADs generated by the first pattern generation unit; and
a first pattern comparison unit for comparing the patterns of the SADs stored in the first pattern storage unit with a predetermined basic pattern of the SADs;
wherein the main detection unit detects the film mode according to a result of comparison by the first pattern comparison unit.

3. The apparatus as claimed in claim 2, wherein the first threshold value calculation unit comprises:
a first minimum value detection unit for detecting a minimum value with respect to five consecutive SADs of the SADs stored in the SAD storage unit; and
a first maximum value detection unit for detecting a maximum value with respect to the five consecutive SADs;
wherein the first threshold value calculation unit calculates the first threshold value based on the detected minimum and maximum values.

4. The apparatus as claimed in claim 3, wherein the first threshold value calculation unit calculates the first threshold value by the following equation,
T1=a×MIN+b×MAX
wherein T1 denotes the first threshold value, a and b are certain values keeping a+b=1, MIN denotes the minimum value of 5 consecutive SADs, and MAX denotes the maximum value of the 5 consecutive SADs.

5. The apparatus as claimed in claim 4, wherein the sub-detection unit comprises:
an absolute change amount calculation unit for calculating the absolute change amount between the calculated SADs;
an absolute change amount storage unit for sequentially storing the absolute change amounts;
a second threshold value calculation unit for calculating a second threshold value using the stored absolute change amounts;
a second pattern generation unit for generating patterns of the absolute change amounts according to the calculated second threshold value;
a second pattern storage unit for sequentially storing the patterns of the absolute change amounts generated by the second pattern generation unit; and
a second pattern comparison unit for comparing the pattern of the absolute change amount stored in the second pattern storage unit with a predetermined basic pattern of the absolute change amount;
wherein the sub-detection unit detects the film mode according to a result of comparison by the second pattern comparison unit.

6. The apparatus as claimed in claim 5, wherein the second threshold value calculation unit comprises:
a second minimum value detection unit for detecting a minimum value with respect to five consecutive absolute change amounts among the absolute change amounts stored in the absolute change amount storage unit; and
a second maximum value detection unit for detecting a maximum value with respect to the five consecutive absolute change amounts;
wherein the second threshold value calculation unit calculates the second threshold value based on the detected minimum and maximum values.

7. The apparatus as claimed in claim 6, wherein the second threshold value calculation unit calculates the second threshold value by the following equation,
T2=a′×MIN′+b′×MAX′
wherein T2 denotes the second threshold value, a′ and b′ are certain values keeping a′+b′=1, MIN′ denotes the minimum value of 5 consecutive absolute change amounts, and MAX′ denotes the maximum value of the 5 consecutive absolute change amounts.

8. The apparatus as claimed in claim 7, wherein the still image judgment unit judges whether the image signal is the still image according to the patterns of the SADs stored in the first pattern storage unit and the patterns of the absolute change amounts stored in the second pattern storage unit.

9. A method for detecting a film mode, comprising:
a main detection step of calculating summed absolute differences (SADs) between 1 period-spaced-fields with respect to an input image signal, and detecting a film mode based on the calculated SADs;
a sub-detection step of calculating absolute change amounts between the calculated SADs, and detecting the film mode based on the calculated absolute change amounts;
a step of judging whether the input image signal is a still image based on the calculated SADs and the absolute change amounts; and
a step of deciding whether the input image signal is in the film mode by combining results of detecting the film mode by the main detection step and by the sub-detection step and a result of judging whether the image signal is the still image by the still image judgment step.

10. The method as claimed in claim 9, wherein the main detection step comprises:
sequentially storing the calculated SADs in a SAD storage unit;
calculating a first threshold value using the sequentially stored SADs;
generating patterns of the SADs according to the calculated first threshold value;
sequentially storing the generated patterns of the SADs in a first pattern storage unit; and
comparing the stored patterns of the SADs with a predetermined basic pattern of the SADs;
wherein the main detection step detects the film mode according to a result of comparison by the SAD pattern comparison step.

11. The method as claimed in claim 10, wherein the first threshold value calculation step comprises:
detecting a first minimum value with respect to 5 consecutive SADs of the SADs stored in the SAD storage unit; and
detecting a first maximum value of the 5 consecutive SADs;
wherein the first threshold value calculation step calculates the first threshold value based on the detected first minimum value and the first maximum value.

12. The method as claimed in claim 11, wherein the first threshold value calculation step calculates the first threshold value by the following equation,
T1=a×MIN+b×MAX
wherein T1 denotes the first threshold value, a and b are certain values keeping a+b=1, MIN denotes the minimum value of 5 consecutive SADs, and MAX denotes the maximum value of the 5 consecutive SADs.

13. The method as claimed in claim 12, wherein the sub-detection step comprises:
sequentially storing the absolute change amounts in an absolute change amount storage unit;
calculating a second threshold value using the stored absolute change amounts;
generating patterns of the absolute change amounts according to the calculated second threshold value;
sequentially storing the patterns of the absolute change amounts generated by a second pattern generation unit; and
comparing the patterns of the absolute change amounts stored in a second pattern storage unit with a predetermined basic pattern of the absolute change amounts;
wherein the sub-detection step detects the film mode according to a result of comparison by the absolute change amount comparison step.

14. The method as claimed in claim 13, wherein the second threshold value calculation step comprises:
a second minimum value detection step of detecting a minimum value with respect to 5 consecutive absolute change amounts among the absolute change amounts stored in the absolute change amount storage unit; and
a second maximum value detection step of detecting a maximum value with respect to the 5 consecutive absolute change amounts;
wherein the second threshold value calculation step detects the second threshold value based on the detected minimum and maximum values.

15. The method as claimed in claim 14, wherein the second threshold value calculation step calculates the second threshold value by the following equation,
T2=a′×MIN′+b′×MAX′
wherein T2 denotes the second threshold value, a′ and b′ are certain values keeping a′+b′=1, MIN′ denotes the minimum value of 5 consecutive absolute change amounts, and MAX′ denotes the maximum value of the 5 consecutive absolute change amounts.

16. The method as claimed in claim 15, wherein the still image judgment step judges whether the image signal is the still image according to the pattern of the SAD stored in the first pattern storage unit and the pattern of the absolute change amount stored in the second pattern storage unit.

17. An apparatus for detecting a 3:2 pull-down sequence, comprising:
a main detection unit for calculating a SAD between 1 period-spaced-fields with respect to an input image signal and detecting a 3:2 pull-down image based on the calculated SADs;
a sub-detection unit for calculating an absolute change amount between the calculated SADs and detecting the 3:2 pull-down image based on the calculated absolute change amounts;
a still image judgment unit for judging whether the input image signal is a still image based on the calculated SADs and the absolute change amounts; and
a 3:2 pull-down sequence decision unit for deciding whether the input image signal is the 3:2 pull-down sequence by combining results of detecting the 3:2 pull-down image by the main detection unit and the sub-detection unit and a result of judging whether the image signal is the still image by the still image judgment unit.

18. A method for detecting a 3:2 pull-down sequence, comprising:
a main detection step of calculating summed absolute differences (SADs) between 1 period-spaced fields with respect to an input image signal, and detecting a 3:2 pull-down image based on the calculated SADs;
a sub-detection step of calculating an absolute change amount between the calculated SADs, and detecting the 3:2 pull-down image based on the calculated absolute change amounts;
a step of judging whether the input image signal is a still image based on the calculated SADs and the absolute change amounts; and
a step of deciding whether the input image signal is the 3:2 pull-down sequence by combining results of detecting the 3:2 pull-down image by the main detection step and the sub-detection step and a result of judging whether the image signal is the still image by the still image judgment step.
